(19) United States
(12) Patent Application Publication
(10) Pub. No.: US 2025/0241506 A1
(43) Pub. Date: Jul. 31, 2025

(54) DISHWASHER DINING TABLE

(71) Applicant: CGECHEN LIMITED, Hamilton (NZ)

(72) Inventor: Song CHEN, Hamilton (NZ)

(73) Assignee: CGECHEN LIMITED, Hamilton (NZ)

(21) Appl. No.: 18/694,255

(22) PCT Filed: Sep. 26, 2022
(86) PCT No.: PCT/NZ2022/050125

§ 371 Date: Mar. 21, 2024

(30) Foreign Application Priority Data
Sep. 27, 2021 (NZ) 780668

(51) Int. Cl. A47L 15/00; A47B 9/00; A47B 33/00; A47L 15/42; A47L 15/50

(52) U.S. Cl. CPC A47L 15/0097; A47B 9/00; A47B 33/00; A47L 15/0018; A47L 15/4261; A47L 15/4263; A47L 15/50; A47L 2401/04; A47L 2501/36

(57) ABSTRACT

A dishwasher table includes a housing with an interior volume for a washing assembly, and a panel located within a frame mounted to the housing. At least one side of the panel defines a utensil surface, with the panel interior volume defining a manifold in communication with a plurality of apertures formed in the utensil surface. A pivot assembly at least partially engages the panel with the housing and pivots the panel to present the utensil surface to the interior of the housing or to face the utensil surface away from the interior of the housing. A vacuum pump is connected to the manifold defined by the interior volume of the panel, and operation of the vacuum pump engages dinning utensils placed over one or more of the apertures formed in the utensil surface with the utensil surface.

### FIELD OF THE INVENTION

This invention relates to a dishwasher dining table where the table surface is inverted while engaging with crockery, glassware and cutlery to face a dishwashing machine deployed within an interior cabinet formed by the body of the table.

### BACKGROUND OF THE INVENTION

Crockery, glassware and cutlery are widely used for food and beverage handling and consumption. For ease of reference these articles are referred to throughout this specification generally as dining utensils. These dining utensils need to be thoroughly cleaned after each and every use.

Dining utensils can be washed by hand in a sink containing hot soapy water and then placed on a bench surface, preferably in a rack, to drain and be manually dried and then stored in a cupboard or drawer. Hand washing dining utensils is a time consuming repetitive monotonous task which few people enjoy. The washing process requires the exclusive use of a sink while dishes are being washed as well as a portion of an adjacent bench surface to drain washed dishes. Dining utensils can also build up in a sink or on an adjacent bench space until a sufficient number has collected to warrant undertaking a manual wash.

Dish washing machines have been developed as an alternative to the manual washing of dishes. These machines employ a cabinet sealed with a door and plumbed with a supply of water and a drain to remove used wash water. High-pressure heated water is supplied to a rotary sprayer arm which directs wash water on to utensils arranged in racks and baskets within the dishwashing machine cabinet.

Dirty dining utensils must be transported from a dining area to the location of the dishwasher and then manually loaded into the machine's racks and baskets. It is also common for dishwasher users to scrape solid food waste from dining utensils and optionally pre-rinse such utensils prior to them being loaded into the dishwashing machine. Users of these machines must wait for a relatively long wash cycle to be completed by the machine before they are called upon to again to manually unload the dishwasher contents into storage shelves and drawers.

One attempt to provide an alternate form of dishwashing machine is described in U.S. Pat. No. 9,402,525. Dining utensils are clipped on to and connected to the upper surface of a table. The table top is flipped over to present the inverted dining utensils to a rotating arm dishwashing system deployed within the interior of the table.

The use of a series of fixed position mechanical connectors by this tabletop dishwashing machine impacts on its usability and detracts from its physical appearance. The mechanical clips used impose limitations on the shapes, sizes and types of crockery, glassware and cutlery which can be connected to the surface of the table. Only dining utensils which are able to engage with these mechanical connectors can be used with this dishwashing system. The mechanical clips used are also unsightly and cannot be hidden or removed from view. Furthermore such clips impede the placement of dining utensils in various locations on the surface of the table which may be desired by a diner. Diners must work around the projecting clips if they wish to move their dining utensils to any other location than apart from being engaged with a clip.

It would be of advantage to have improvements in the field of dishwashing machines which addressed any or all of the above issues or at least provided the public with an alternative choice. An improved dishwashing machine integrating a washing system into the interior of a table and having the capacity to attach utensils to a table surface for inversion and exposure to this washing system without the use of a physical clips would be of particular advantage.

### DISCLOSURE OF THE INVENTION

According to one aspect of the present invention there is provided a dishwasher table which includes
a housing which defines an interior volume which locates a washing assembly,
a panel located within a frame mounted to the housing, at least one side of the panel defining a utensil surface, the panel incorporating an interior volume which defines a manifold in communication with a plurality of apertures formed in the utensil surface,
a pivot assembly which at least partially engages the panel with the housing and allows the panel to move to present the utensil surface to the interior of the housing or to face the utensil surface away from the interior of the housing, a vacuum pump connected to the manifold defined by the interior volume of the panel, whereby operation of the vacuum pump engages dinning utensils placed over one or more of the apertures formed in the utensil surface with the utensil surface.

According to another aspect of the present invention there is provided a dishwasher table substantially as described above which also includes a filter connected between the vacuum pump and manifold defined by the interior volume of the panel, the filter being arranged to separate solids and liquids from gases drawn through the manifold and to supply substantially only gas to the vacuum pump.

According to another aspect of the present invention there is provided a dishwasher table substantially as described above which includes a coverage sensor associated with each aperture formed in the utensil surface, wherein a coverage sensor is adapted to provide an output signal which indicates if the aperture is covered by a dining utensil.

According to a further aspect of the present invention there is provided a dishwasher table substantially as described above which includes a valve assembly associated with each aperture formed in the utensil surface, wherein said valve assembly is adapted to block access to the manifold when an associated coverage sensor indicates the aperture is not covered by a dining utensil.

According to a further aspect of the present invention there is provided a method of operating a dishwasher table substantially as described above characterised by the steps of:
i. operating the vacuum pump to engage dining utensils placed over one or more of the apertures formed in the utensil surface with the utensil surface,
ii. using the pivot assembly to move the panel and present the utensil surface to the interior of the housing,
iii. activating the washing assembly located within the interior volume of the housing to wash the dining utensils suspended from the utensil surface.

According to another aspect of the present invention there is provided a method of operating a dishwasher table substantially as described above characterised by the steps of:
i. opening a valve associated with any aperture formed in the utensil surface when an associated coverage sensor indicates the aperture is covered by a dining utensil,
ii. operating the vacuum pump to engage dining utensils placed over one or more of the apertures formed in the utensil surface with the utensil surface,
iii. using the pivot assembly to move the panel and present the utensil surface to the interior of the housing,
iv. activating the washing assembly located within the interior volume of the housing to wash the dining utensils suspended from the utensil surface.

In various aspects of the present invention provides a dishwasher dining table and a method of operating a dishwasher dining table. The dishwasher dining table provided incorporates a surface which is inverted when engaged with crockery, glassware and cutlery to expose these dining utensils to a washing assembly. Reference in general throughout this specification will predominantly be made to the invention providing a dishwasher table, although those skilled in the will also appreciate that a method of operating such a dishwasher dining table is also within the scope of the invention.

The dishwasher table provided incorporates a housing which defines an interior volume and which has a frame mounted to this house. A panel is located within the frame mounted to the housing and the panel is used to close or cover the interior volume defined by the housing.

The interior volume of the housing is used to locate a washing assembly configured to wash dining utensils located within the interior volume of the housing. Those skilled in the art will appreciate that a variety of different forms of washing assembly may be used in conjunction with the present invention and be located within the housing's interior volume. For example in some possible embodiments a washing assembly may incorporate a rotating spray arm which directs jets of hot water towards dining utensils within the interior volume of the housing to clean these utensils. In other alternative embodiments the invention may incorporate a washing assembly which provides a reciprocating spray arm. This spray arm may move linearly along the length or width of the interior volume of housing to again spray jets of hot water towards utensils located within this volume.

In preferred embodiments at least one side of the panel used to close or cover the interior volume of the housing defines a utensil surface. A utensil surface can be used to support dining utensils placed on this surface.

Preferably a panel provided in accordance with the invention incorporates an interior volume which defines a manifold in communication with a plurality of apertures formed in the utensil surface. Each of these apertures can extend from the utensil surface through to this interior manifold volume.

Reference in general will be made throughout this specification to a panel defining a single utensil surface which has a plurality of apertures communicating with an interior volume manifold. However those skilled in the art will the appreciate that both opposed faces of the panel may be used in some embodiments to define two separate utensil surfaces, each surface incorporating a plurality of apertures which communicate with the interior volume manifold of the panel.

The present invention incorporates a vacuum pump connected to the manifold defined by the interior volume of the panel. This vacuum pump can be operated to engage dining utensils placed over one or more of the apertures formed in the panel's utensil surface with the utensil surface. This vacuum pump can therefore connect dining utensils to the utensil surface when activated, and disconnect these utensils from the utensil surface when deactivated.

In a preferred embodiment the invention may include a filter connected between the vacuum pump and the manifold defined by the interior volume of the panel. This filter can be arranged to separate solids and liquids from gases drawn through the manifold, and to supply substantially only gas to the vacuum pump to ensure effective operation of this component.

In a further preferred embodiment such a filter may be formed by a separation chamber divided by an internal baffle with an inlet port and outlet port located on either side of this baffle. These ports can be provided in the upper region of the separation chamber with the internal baffle forming a barrier between the ports and extending downwards to define a passage or channel at the lower region of the chamber. This arrangement will allow unwanted solid and liquid materials to collect and be trapped in the lower region of the separation chamber with gases being drawn from the inlet port, under the internal baffle and out through the outlet port. In various preferred embodiments a separation chamber may also include a drain to allow for the removal of the solids and liquids which it collects.

Preferably the panel may be mounted within the frame using one or more seals deployed between the panel and frame.

Preferably the present invention incorporates a pivot assembly used to at least partially engage the panel with the housing. In various embodiments this pivot assembly may be used to fully support the weight of the panel and engage with the housing, whereas in other embodiments the panel may also be provided with a connection to the frame in addition to a connection or connections to the pivot assembly. Reference in general throughout this specification will be made to the panel being solely connected to the pivot assembly and mounted within the frame using one or more seals deployed between the panel and frame. Those skilled in the art will however appreciate that a range of connection systems and assemblies may be employed by the invention in various embodiments.

A pivot assembly provided with the invention allows and is used to move the panel so as to present the utensil surface to the interior volume of the housing, or to move the panel so as to orientate the utensil surface away from the interior of the housing. The pivot assembly can therefore operate to present the utensil surface as the upper surface of the dishwasher table when the table is used by diners, and then to present the utensil surface engaged with dining utensils to the interior volume of the housing once diners have finished eating and/or drinking.

In a preferred embodiment a pivot assembly provided with the invention may include at least one axle engaged in substantially the middle of one side of the panel. This axle or axles can be engaged with a bearing assembly to allow rotation of the panel relative to the frame and housing of the dishwasher dining table provided. In a further preferred embodiment the pivot assembly may include a pair of such axles positioned opposite one another on opposed sides of the panel. The use of two such axles allows the weight of the panel to be evenly supported when pivoted.

In a preferred embodiment at least one axel incorporated into a pivot assembly may be engaged with a drive motor. This drive motor can be used to apply a rotational force to the panel to pivot the panel relative to the table frame and housing.

In a preferred embodiment a pivot assembly may include at least one lifting arm engaged between an axle of the pivot assembly and the table housing. This lifting arm or arms may move to lift the panel above and out of the frame away from the housing prior to the panel being pivoted and preferably inverted relative to the table housing. Raising the panel in this manner increases clearance between the interior volume of the housing and edges of the panel as these edges are rotated through this volume.

This arrangement of components facilitates the invention providing a method of operating a dishwasher table. The table's vacuum pump may be operated to engage dining utensils placed over one or more of the apertures formed in the utensil surface with the utensil surface. Then the pivot assembly can be used to move the panel and present the utensil surface to the interior of the housing. Once the panel has been inverted with dining utensils suspended from the utensil surface the washing assembly located within the interior of the housing can be activated to wash the dining utensils.

In a preferred embodiment the dishwasher table provided may include a coverage sensor associated with each aperture formed in the utensil surface. These coverage sensors can be adapted to provide an output signal which indicates if the aperture is covered by a dining utensil.

In a preferred embodiment a coverage sensor may be formed by an optical sensor which detects the presence or absence of light and which issues a signal based on its reception of light. The coverage of an aperture by a dining utensil will block light reaching the sensor triggering the sensor to issue a signal indicating that the aperture is covered.

In other embodiments are coverage sensor may actively emit infrared radiation, with the reflection of such radiation back to the sensor indicating that the associated utensil surface aperture has been covered by a dining utensil.

Reference in general will also be made throughout the specification to the invention using coverage sensors formed by optical sensors. However those skilled now also appreciate that various types of magnetic, capacitive or mechanical based sensors may alternatively be used in other embodiments.

In a preferred embodiment the dishwasher table provided may include a valve assembly associated with each aperture formed in the utensil surface. Each of these valve assemblies can be adapted to close and block access to the manifold when an associated coverage sensor indicates the aperture is not covered by a dining utensil.

In a further preferred embodiment a valve assembly may include a spring loaded piston movable to block or expose an entry port of the manifold, the piston being moved by an electrical solenoid, wherein action of the electrical solenoid compresses the spring of the piston and exposes the manifold entry port. In such embodiments the valve assembly will by default close the entry port of the manifold by the spring associated with the piston urging it into a blocking position. Only with the activation of the electrical solenoid will the piston be moved away from the manifold port, with this movement also compressing or loading the piston spring.

In a preferred embodiment the dishwasher table provided may incorporate a microcomputer or microcontroller connected to the plurality of coverage sensors and valve assemblies. This microcontroller may be configured to receive signals from coverage sensors and issue control signals to the valve assemblies associated with these coverage sensors. The microcontroller can be programmed to ensure that a valve assembly is closed when it's associated aperture which has not been closed or covered by a dining utensil, and to ensure that a valve assembly is opened when an associated aperture has been covered by a dining utensil. In this way the combination of coverage sensors, valve assemblies and control system can operate to avoid a loss of vacuum pressure through utensil surface apertures which are not covered by dining utensils, thereby firmly engaging dining utensils which cover such apertures with the utensil surface.

This particular arrangement of components facilitates the invention providing an additional method of operating a dishwasher table. When executed this method results in the closure of a valve associated with any aperture formed in the utensil surface when an associated coverage sensor indicates the aperture is not covered by a dining utensil. The vacuum pump can then be operated to engage dining utensils covering the apertures of the utensil surface with the utensil surface, and the pivot assembly can be used to move and invert the panel to present the utensil surface to the interior of the housing. Once the dining utensils are engaged with the utensil surface and the panel has been inverted the washing assembly located within the interior volume of the housing can be activated to wash the dining utensils suspended from the utensil surface.

The present invention may provide many potential advantages over the prior art. In various embodiments the invention facilitates providing a dishwasher dining table. This machine allows its users to avoid having to hand wash dishes and laminates any requirement for dishes to be removed to a remote location for washing. Users of the invention simply need to ensure the vacuum pump that it incorporates is activated and then invert the utensil surface of the top panel of the table to expose their dining utensils to the action of the washing assembly incorporated into the interior housing of the table. Through its use of a vacuum pump connected via a manifold to an array of apertures in the panels utensil surface the invention eliminates the need for any mechanical clips to be permanently mounted to the panel.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows a perspective view of a dishwasher table as provided in accordance with one embodiment of the invention,

FIG. 2 shows a perspective transparent view of the dishwasher table of FIG. 1 illustrating the use of a pivot assembly to move a panel used to form part of the dishwasher table, and

FIG. 3 shows a perspective transparent view of the panel of FIGS. 1 and 2,

FIG. 4 shows a side cross section view of the panel of FIG. 3,

FIG. 5 shows a side cross section modular view of internal components of the dishwasher table of FIGS. 1 and 2, and

FIGS. 6a and 6b show schematic views of liquid and gas circulation components integrated into the interior volume of the dishwasher table of FIGS. 1 and 2,

FIG. 7 shows sensor and control signal connections provided with a microcomputer control system integrated into the dishwasher table of FIGS. 1 and 2, and

FIGS. 8a, 8b and 8c show a combined coverage sensor and valve assembly from FIG. 3 in further detail.

Further aspects of the invention will become apparent from the following description of the invention which is given by way of example only of particular embodiments.

### BEST MODES FOR CARRYING OUT THE INVENTION

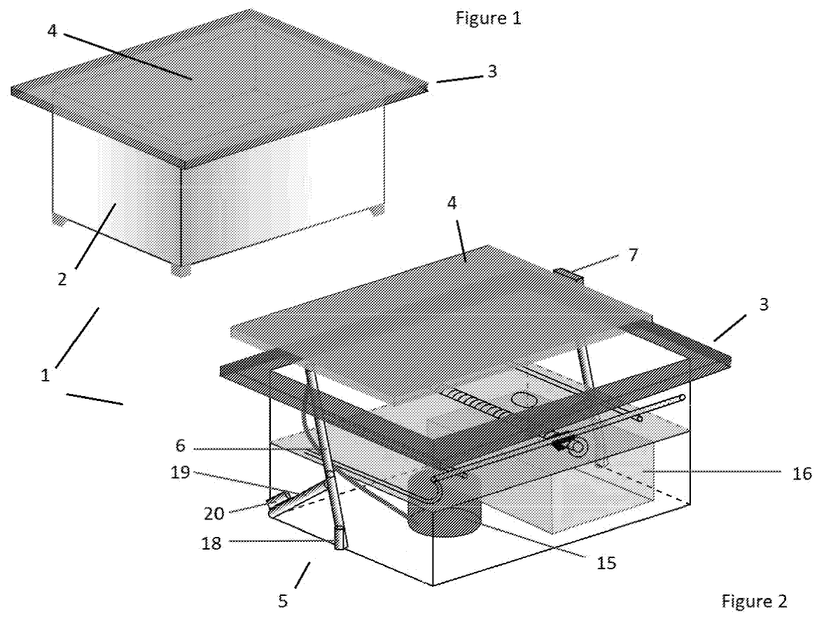

FIG. 1 shows a perspective view of a dishwasher table as provided in accordance with one embodiment of the invention. FIG. 2 shows a perspective transparent view of the same dishwasher table, illustrating the use of a pivot assembly to move a panel used to form part of the dishwasher table.

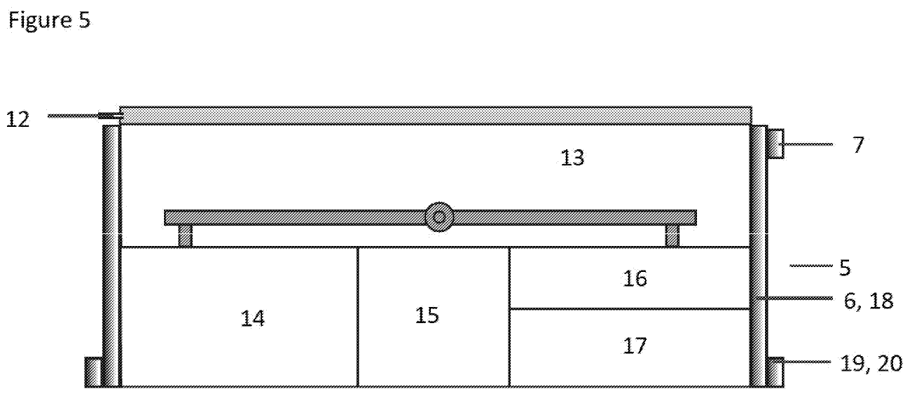

In the embodiment shown the dishwasher table 1 incorporates a housing 2 where the upper surface of this housing is connected to a frame 3 and panel 4. The housing defines an interior volume which locates various internal components of a washing assembly, as discussed further with respect to FIGS. 5 through 7.

FIG. 2 illustrates the action of a pivot assembly 5 provided as part of the dishwasher table. In this embodiment the pivot assembly incorporates a pair of lifting arms 6 linked to axles (not shown) engaged with the centre axis of the panel. A drive motor 7 is connected between one of these lifting arms and an axle so that activation of the motor causes the panel to pivot and ultimately be inverted relative to the arrangement shown with respect to FIG. 1.

As can be seen from FIG. 2 each lifting arm is used to lift the panel above and out of the frame away from the housing prior to the panel being pivoted. Raising the panel in this manner increases clearance between the interior volume of the housing and the edges of the panel as these edges are rotated through this volume.

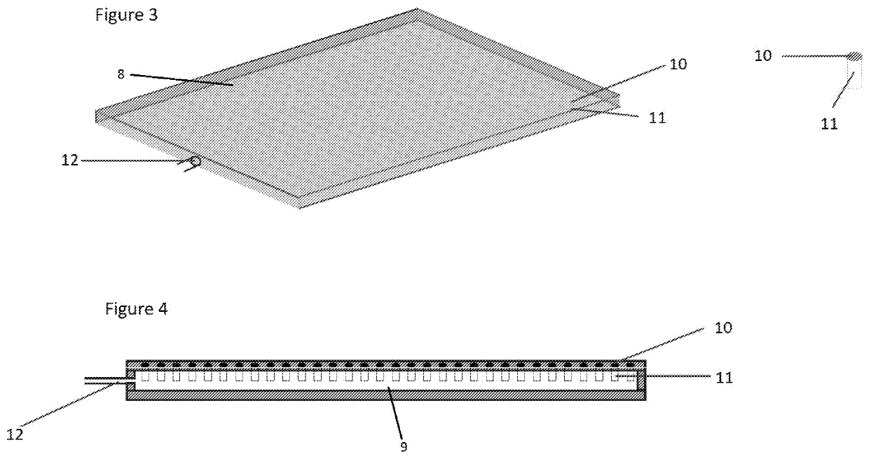

FIG. 3 shows a perspective transparent view of the panel of FIGS. 1 and 2, while FIG. 4 shows a side cross section view of the same panel. In the embodiment shown the upper face of the panel defines a utensil surface 8 which is to be used to support the dining utensils employed by users of the table. As can be seen from FIG. 4 the panel incorporates an interior volume which defines a manifold 9 in communication with an array of apertures 10 formed in this utensil surface. Each aperture locates a combined coverage sensor and valve assembly 11. Each coverage sensor can detect if the aperture it is housed within has been covered by a dining utensil, and the associated valve assembly can be opened and closed in response to the signal provided by this coverage sensor. These components can therefore be used to maximise the vacuum pressure applied to covered apertures by a vacuum pump (not shown) connected to the outlet 12 of the panel manifold.

The dishwashing table shown may be used by diners conventionally, placing their dining utensils wherever they desire on the utensil surface of the panel. When these utensils are to be washed each coverage sensor can trigger the closure of an associated valve assembly if it detects that no dining utensil covers the aperture housing these components. This approach will maximise the vacuum pressure applied to dining utensils which do cover such apertures, allowing the vacuum pump to be activated and the pivot assembly to be used to both lift, pivot and then invert the utensil surface to face the interior volume of the housing. The dining utensils to be washed can then be suspended from the inverted utensil surface to be exposed to sprays of washing water delivered by the washing assembly located in the interior of the table housing.

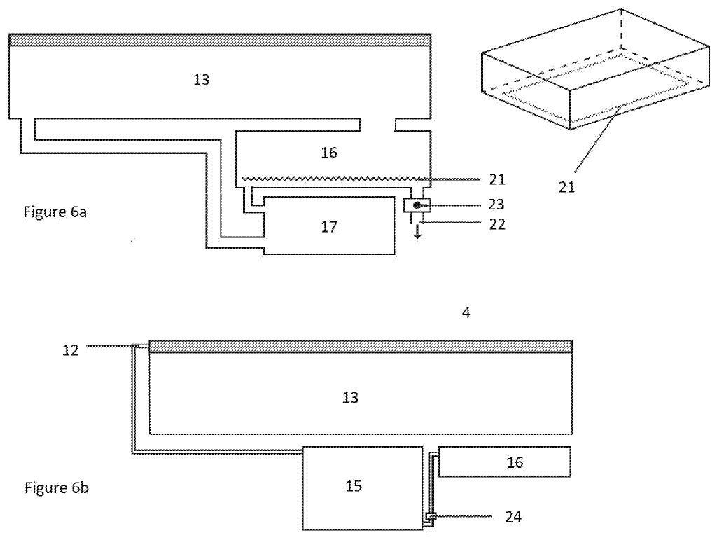

FIG. 5 shows a side cross section modular view of internal components of the dishwasher table of FIGS. 1 and 2. FIGS. 6a and 6b also show schematic views of liquid and gas circulation components integrated into the interior volume of the dishwasher table of FIGS. 1 and 2.

As can be seen from FIG. 5 the interior volume of the housing is used to locate components of a washing assembly inside an upper cleaning pool 13 which is located above a microcomputer control system 14, vacuum pump 15, water reservoir 16 and water pump 17. FIG. 5 also illustrates part of the pivot assembly employed in this embodiment including drive motor 7, lifting arm 6 and associated actuation motor 18, in addition to a lifting arm pushrod 19 and associated actuation motor 20.

FIG. 6a shows the interconnections provided between the water pump 17, upper cleaning pool 13 and water reservoir 16. As can be seen from this figure the water reservoir 16 includes a heating wire 21 connected to and controlled by the microcomputer control system 14 to adjust the temperature of water pumped into the upper cleaning pool 13. The water reservoir 16 is also linked to a drainage outlet 22 with an associated drain valve 23, again controlled by the microcomputer control system.

FIG. 6b shows the connections made between a vacuum pump 15, panel manifold outlet 12 and a drain pump 24 and water reservoir 16. As can be seen from this figure the vacuum pump 15 can apply a vacuum to the panel manifold, drawing gases, liquids and solids through the interior of the panel 3. The connected drain pump 24 can be used to recirculate liquid inadvertently supplied to the vacuum pump 15 through to the water reservoir 16.

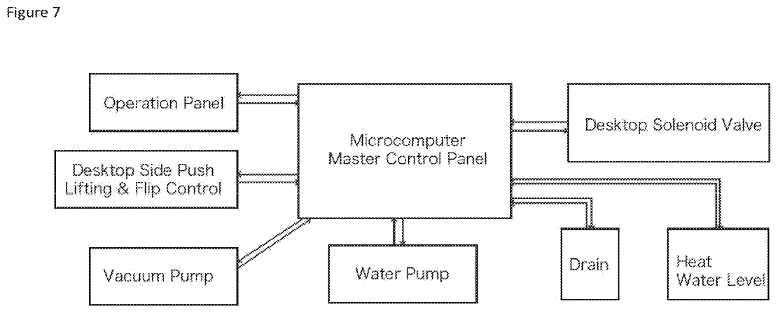

FIG. 7 shows sensor and control signal connections provided with a microcomputer control system integrated into the dishwasher table of FIGS. 1 and 2. The microcontroller receives various input signals from each of the components illustrated and is capable of issuing control signals to these components to operate the dishwasher table provided.

As can be seen from FIG. 7 the microcomputer is able to receive signals from and control the pivot assembly motors identified as the desktop solenoid valve and desktop side push lifting and flip controls. Connections are also provided to the vacuum pump, drain valve and water reservoir heating wire. The microcomputer is also connected to an operation panel which displays information to the users of the invention about the operation of the dishwasher table and allows for user adjustments of how the table operates.

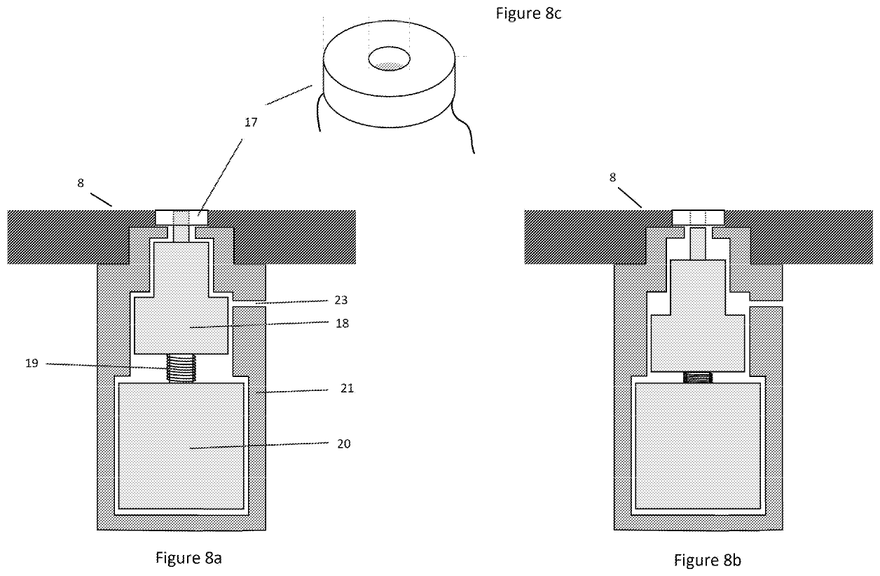

FIGS. 8a and 8b show a combined coverage sensor and valve assembly 11 from FIG. 3 in further detail. FIG. 8c shows a perspective view of the top of the assembly in isolation. The sensor is formed by a ring shaped photo-resistor 17 which sits flush with the utensil surface 8. The valve includes a piston 18 driven by a spring 19 and electrical solenoid 20 so that the valve housing 21 and the body of the piston 18 closes both an air passage 22 to the manifold and an air passage 23 through the middle of the photo-resistor 17.

FIG. 8a shows the valve assembly in a closed state where air cannot be drawn into the manifold. FIG. 8b. The view provided as FIG. 8b shown the valve in an open state where the piston no long blocks the flow of air through passages 22, 23.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A dishwasher table, comprising:
a housing which defines an interior volume which locates a washing assembly,
a panel located within a frame mounted to the housing, at least one side of the panel defining a utensil surface, the panel incorporating an interior volume which defines a manifold in communication with a plurality of apertures formed in the utensil surface,
a pivot assembly which at least partially engages the panel with the housing and allows the panel to move to present the utensil surface to the interior of the housing or to face the utensil surface away from the interior of the housing, and
a vacuum pump connected to the manifold defined by the interior volume of the panel, whereby operation of the vacuum pump engages dinning utensils placed over one or more of the apertures formed in the utensil surface with the utensil surface.

2. The dishwasher table as claimed in claim 1, further comprising a coverage sensor associated with each aperture formed in the utensil surface, each coverage sensor being adapted to provide an output signal which indicates if the aperture is covered by a dining utensil.

3. The dishwasher table as claimed in claim 2, further comprising a valve assembly associated with each aperture formed in the utensil surface, each valve assembly being adapted to block access to the manifold when an associated coverage sensor indicates the aperture is not covered by a dining utensil.

4. The dishwasher table as claimed in claim 3, wherein the valve assembly includes a spring loaded piston movable to block or expose an entry port of the manifold, the piston being moved by an electrical solenoid, wherein activation of the electrical solenoid compresses the piston spring and exposes the manifold entry port.

5. The dishwasher table as claimed in claim 2, wherein a coverage sensor is formed by an optical sensor which detects the presence or absence of light and issues a signal.

6. The dishwasher table as claimed in claim 5, wherein the coverage of an aperture by a dining utensil blocks light reaching the sensor triggering the sensor to issue a signal indicating that the aperture is covered.

7. The dishwasher table as claimed in claim 2, wherein a coverage sensor actively emits infrared radiation, with the reflection of infrared radiation back to the sensor indicating that the associated utensil surface aperture has been covered by a dining utensil.

8. The dishwasher table as claimed in claim 3, further comprising a microcontroller connected to the plurality of coverage sensors and valve assemblies, the microcontroller being configured to receive signals from coverage sensors and issue control signals to valve assemblies.

9. The dishwasher table as claimed in claim 8, wherein the microcontroller is programmed to open a valve assembly when an associated aperture has been covered by a dining utensil.

10. The dishwasher table as claimed in claim 1, wherein the panel is mounted within the frame using one or more seals deployed between the panel and frame.

11. The dishwasher table as claimed in claim 1, wherein the pivot assembly operates to present the utensil surface as the upper surface of the dishwasher table when the table is used by diners and to present the utensil surface engaged with dining utensils to the interior volume of the housing.

12. The dishwasher table as claimed in claim 1, wherein pivot assembly includes at least one axle located in substantially the middle of one side of the panel, said at least one axle being engaged with a bearing assembly allowing rotation of the panel relative to the frame and housing.

13. The dishwasher table as claimed in claim 12, further comprising a pair of axles positioned opposite one another on opposed sides of the panel.

14. The dishwasher table as claimed in claim 12, wherein at least one axle is engaged with a drive motor used to apply a rotational force to the panel to pivot the panel relative to the table frame and housing.

15. The dishwasher table as claimed in claim 12, wherein the pivot assembly includes at least one lifting arm engaged between an axle of the pivot assembly and the table housing, the lifting arm or arms being configured to lift the panel above and out of the frame away from the housing prior to the panel being pivoted relative to the table housing.

16. The dishwasher table as claimed in claim 1, further comprising a filter connected between the vacuum pump and manifold defined by the interior volume of the panel, the filter being arranged to separate solids and liquids from gases drawn through the manifold and to supply gas to the vacuum pump.

17. The dishwasher table as claimed in claim 16, wherein the filter includes a separation chamber divided by an internal baffle with an inlet port and outlet port located on either side of the baffle.

18. The dishwasher table as claimed in claim 16, wherein the separation chamber includes a drain to allow for the removal of the solids and liquids.

19. A method of operating the dishwasher table as claimed in claim 1, comprising the steps of:
i. operating the vacuum pump to engage dining utensils placed over one or more of the apertures formed in the utensil surface with the utensil surface,
ii. using the pivot assembly to move the panel and present the utensil surface to the interior of the housing, and
iii. activating the washing assembly located within the interior volume of the housing to wash the dining utensils suspended from the utensil surface.

20. The method of operating a dishwasher table as claimed in claim 19, further comprising an additional preliminary step of opening a valve associated with any aperture formed in the utensil surface when an associated coverage sensor indicates the aperture is covered by a dining utensil prior to operating the vacuum pump.
